(19) United States
(12) Patent Application Publication
(10) Pub. No.: US 2019/0009370 A1
(43) Pub. Date: Jan. 10, 2019

(54) LASER TEXTURING OF STEEL STRIP

(71) Applicant: TATA STEEL NEDERLAND TECHNOLOGY B.V., Velsen-Noord (NL)

(72) Inventors: David Thomas Allan MATTHEWS, BORNE (NL); Hasib MUSTAFA, ENSCHEDE (NL); Gerardus Richardus Bernadus Engelina RÖMER, ?s-HEERENBERG (NL); Derk Jan WENTINK, HAARLEM (NL)

(73) Assignee: TATA STEEL NEDERLAND TECHNOLOGY B.V., Velsen-Noord (NL)

(21) Appl. No.: 16/070,154

(22) PCT Filed: Jan. 19, 2017
(86) PCT No.: PCT/EP2017/051089

§ 371 Date: Jul. 13, 2018

(30) Foreign Application Priority Data
Jan. 22, 2016 (EP) 16152436.8
May 30, 2016 (EP) 16172035.4

(51) Int. Cl. B23K 26/352; B23K 26/08; B23K 26/067

(52) U.S. Cl. CPC B23K 26/355; B23K 2101/16; B23K 26/0673; B23K 26/0846

(57) ABSTRACT

A method and an arrangement for finishing a steel strip including the texturing of the steel strip wherein a texture is applied to the surface of a moving steel strip by means of a single laser beam or a plurality of laser beams directed at the surface of a moving steel strip, and wherein the single laser beam or the plurality of laser beams are position controlled to apply a predetermined texture pattern on the surface of the moving steel strip.

### FIELD OF THE INVENTION

The invention relates to laser texturing of steel strip and to an apparatus and a configuration for laser texturing steel strip.

### BACKGROUND OF THE INVENTION

In the finishing of (coated) steel strip, a steel strip is subjected to levelling and/or temper rolling. With levelling the shape and form of the strip are controlled and with temper rolling the mechanical properties of the steel strip are improved by lengthening of the strip and by orientation of the grains in the steel in the rolling direction. Also the surface quality of the strip is improved as far as it concerns appearance, surface texture and surface function(ality). With the temper rolling step a texture may be transferred to the surface of the strip from the work rolls to get a certain function, such as, but not limited to, appearance, a better adhesion of paint, tribological properties and improved forming properties of the steel strip. The texturing of the steel strip is done to the requirements of the end user, for instance end users in the automotive industry.

To apply a texture to a steel strip at least one of the temper work rolls in contact with the steel strip, is provided with a certain texture on the roll surface, such that an impression of which is transferred to the surface of the steel strip when passing through the temper mill. Since the texture on the texture transfer roll wears out, and/or becomes fouled, the required texture has to be renewed or applied again frequently. For the texturing of the texture transfer roll surface, various techniques are available but even with the more durable applied textures the major drawback is that they all have a certain but limited stand time. This has become an even larger drawback with the increasing application of high strength steels over a wide product range.

Another drawback is that for the application of different textures the texture transfer roll has to be changed resulting in time and hence production losses. Additionally, if different textures are required on the strip on different locations, either within the roll width, outside the length of the roll circumference, or on the top or bottom of the steel strip this cannot be achieved with conventional single stand rolling mills.

### OBJECTIVES OF THE INVENTION

It is an objective of the present invention to provide a method and apparatus for texturing steel strip wherein the texturing is done separately from the temper rolling of the steel strip.

It is another objective of the present invention to provide a method and apparatus for texturing steel strip wherein the texturing is done without a direct mechanical contact with the steel strip.

It is another objective of the present invention to provide a method and apparatus for texturing steel strip wherein the applied texture can be changed without interruption of the rolling process.

It is another objective of the present invention to provide a method and apparatus for texturing steel strip wherein the texture can be changed over the width and the length of the strip.

It is another objective of the present invention to provide a method and apparatus for texturing steel strip wherein the texturing can be done at a wide range of rolling speeds.

It is still another objective of the present invention to provide a method and apparatus for texturing steel strip wherein the texturing can be done at less net costs in comparison with texturing according to the prior art.

### DESCRIPTION OF THE INVENTION

According to a first aspect of the invention one or more of the objectives of the invention are realized by providing a method for finishing a steel strip comprising the texturing of the steel strip wherein a texture is applied to the surface of a moving steel strip, and wherein
a single laser beam or a plurality of laser beams is directed at the surface of a moving steel strip, and
the single laser beam or the plurality of laser beams are controlled to apply a predetermined texture pattern on the surface of the moving steel strip.

In order to be able to apply a texture pattern on a moving steel a laser beam or laser beams are used which can either be pulsed laser beams or continuous wave laser beams which modify the strip steel surface. In case a pulsed laser source is used, pulse durations in the nano-, pico or femto-second regime are preferably used, to obtain well defined textures in the micrometer range without that the rest of the strip or the coating is thermally affected or at least not significantly thermally affected.

The term “steel strip” shall mean “steel strip” as well as “coated steel strip”.

The strip surface is textured using a non contact method which in this case is by means of electromagnetic radiation, more specifically by laser. Instead of laser texturing also other energy beams could be used for texturing, in particular by means of electron- or ion beams. With texturing by means of electron- or ion beams a vacuum is needed to apply a texture which requires additional measures in comparison with the laser texturing method according to the invention.

A single laser beam is sufficient to apply a texture pattern on a moving steel strip, however if different texture patterns alongside of each other or when broad steel strips have to be provided with texture patterns it is advantageous to have more than a single laser beam available. To that end, it is provided that the laser beams are divided in groups each with a single laser beam or a plurality of laser beams, which groups are controlled separately. With multiple laser beams it will be possible and/or easier to control the laser beams to provide a broad strip with a texture pattern or where different texture patterns have to be applied next to each other on a moving steel strip.

According to a further aspect of the invention it is provided that the groups of laser beams are positioned over the width and/or direction of movement of the steel strip with respect to each other. By positioning the groups of laser beams over the width of the path of a moving steel strip the application of a texture pattern or patterns across the width can be controlled more easily. By positioning the groups of laser beams over the direction of movement of a moving steel strip the application of a texture pattern in successive steps can be controlled more easily. Such a texture pattern could for instance comprise successive texture types in line with each other. If the application of a texture patterns raises the temperature of the steel strip locally it could be advantageous to apply an adjacent part of the texture a little later to let the area around a part of an applied part of the texture on the steel strip first cool down. With such a setup the groups of a single or a plurality of laser beams could be positioned in line with each other with regard of the direction of movement of the steel strip.

This is not absolutely necessary and according to a further aspect of the invention it is provided that the groups of laser beams are controlled such that adjacent parts of the texture are applied with different groups of laser beams wherein the groups have different positions with respect to each other. Applying the texture pattern with more than one group of laser beams at an angle from another position can be done without great difficulty.

According to a further aspect of the invention a texture pattern is applied by controlling two or more groups of laser beams to form an interference pattern showing a power density distribution suitable for texturing of the moving steel strip. By using interference of laser beams to apply a texture pattern a large range of different patterns become available. For instance use can be made of laser beams that are fixed in one specific direction, such as perpendicular to the moving steel strip, which if necessary are only controlled in Z-direction, in combination with laser beams that are directed also in the X- and/or Y-direction. Another setup is to combine laser beams that are all controllable in all directions. Furthermore, continuous wave laser beams can be used in combination with pulsed laser beams or only continuous wave laser beams can be used. Furthermore, a protective and/or shroud gas may be used to avoid oxidation of the processed strip and/or remove and/or prevent debris material from interfering with the laser-material interaction zone of the processed strip. Alternatively, the shrouding gas may be applied to the laser-material interaction zone to chemically alter the processed surface.

According to a further aspect of the invention the control comprises the control of one or more of the laser beams and the position thereof within one or more of the different groups of laser beams. With such a control the possibilities to apply a texture pattern are further increased.

In order to control a single laser beam or a plurality of laser beams the control comprises the focussing of laser beams into image points on or near the surface of the moving steel strip, and/or modulation of the power of the laser beam or beams and/or, shaping or reshaping of the power density of the laser beam or beams.

The control further comprises a correction for changes in the Z-direction of the moving steel strip. Since a moving steel strip will inevitably deviate from the imaginary flat path through at least part of the rolling mill a correction of the laser beams in the Z-direction may be necessary. This can be achieved by for example mechanically changing the relative position of the focussing device to the moving steel strip and/or optically changing the diameter of the laser beam(s) entering the focussing device, for example by the use of a lens or a variable beam expander.

Preferably the texturing is carried out after temper rolling and/or levelling of the steel strip.

The method according to the invention is suitable to be used with a line speed of the steel strip is in a range up to and including 15 m/s. By using fast and high peak power laser beams the method can be used by any of the rolling speeds used in the industry. However, the setup and control of the laser beam or laser beams in the method is such that a texture pattern can also be applied at lower speeds or when the steel strip not moving at all.

Where in the method a pulsed single laser beam or a plurality of pulsed laser beams are used it is provided that:

the pulse duration is in the range of 1 fs to 100 ms,

the electromagnetic radiation of each laser beam has a wave length between 200 nm-11 μm, and

with an energy density of each laser beam in the range of 1 nJ/cm²-100 J/cm², preferably in the range of 0.1 J/cm² to 10 J/cm².

The energy density of each laser beam is as measured in the laser spot at the strip surface.

Preferably a pulse duration is used of less than 1 ns, even more preferably less than 100 ps.

These ranges comprise ultrafast and high peak power pulsed laser, i.e. lasers which are fast and powerful enough to apply a texture pattern on a moving steel strip at any speed used in the steel industry in the processing of steel strip.

According to a further aspect of the invention the pulsed laser beam or beams used in the method have a pulse frequency in the range of 1 Hz to 5 GHz, wherein the frequency is dependent on the density of the texture, the size of the strip, and the velocity of the strip, and wherein the diameter of the laser beam on the surface of the strip is in the range of 10 nm to 1 mm.

Depending on the type of the texture that has to be applied the diameter of the laser beam on the surface of the strip may also be outside this range.

The invention further provides for an arrangement for the finishing of steel strip comprising at least one laser beam source to generate a single laser beam or a plurality of laser beams to apply a texture to the surface of a moving steel strip, and control means to control the single laser beam or plurality of laser beams to apply a texture on a moving steel strip.

According to a further aspect of the invention the control means are designed to combine two or more laser beams to form an interference pattern with a power density distribution suitable for texturing of the moving steel strip. With such a setup the laser beams or part of the beams could be continuous wave laser beams, instead of pulsed laser beams.

The arrangement further comprises a laser beam splitter for one or more of the laser beam sources to split the laser beam from a laser beam source into a plurality of laser beams. In this way a plurality of laser beams or different groups of single laser beams and/or different groups with a plurality of laser beams can be obtained from a single laser beam source.

According to a further aspect the arrangement comprises a focusing element for each laser beam, or plurality of laser beams, to focus the laser beam or laser beams to one or more predetermined points. The control of the focussing element for the laser beams is a continuous control because of the inevitable variations of the moving steel strip in the Z-direction.

According to still a further aspect the arrangement comprises a beam expander and a laser beam shaper between laser beam source and related laser beam splitter or focusing elements, or between other optical elements. The arrangement further comprises at least one position controlled laser beam deflector is provided in the laser beam path, to deflect the laser beam in one or more directions. Such a laser beam deflector can consist of Galvano(meter)-scanner(s), piezo-scanner(s), Micro-Electro-Mechanical System (MEMS) scanner(s), rotating polygon wheel scanners, optical solid state deflectors, which rely on the electro-optical or acousto-optic effect, or the like, or a combination of these technologies.

According to a further aspect of the invention, the arrangement comprises a number of laser beam devices which are positioned over the width and in the length of the path of the steel strip through the arrangement. Such a laser beam device could be a laser beam source or a laser beam derived from one or more common laser beam sources.

The control means of the arrangement are designed to control the laser beam source and/or the beam expander, beam splitter, focusing element(s), beam shaper(s) and deflectors in the path of the laser beam coming from a laser beam source. The control means is largely a software regulated control system to control the devices in the laser texturing part of the arrangement and with the necessary sensors to monitor changes in the process and adapt the control to these changes and to a control programme for the texture pattern.

It is further provided that the arrangement comprises a temper roll mill and wherein the temper roll mill is provided with a roll with a roughness Ra (λc=2.5 mm) less than 6 μm and preferably less than 2 μm. Since the texturing is applied by means of laser texturing there is no longer need for the use of textured rolls. However, in order to have sufficient grip on the steel strip at least one of the rolls needs to have a certain roughness.

### BRIEF DESCRIPTION OF THE DRAWINGS

The invention will be further explained on hand of the example shown in the drawing, in which:

FIG. 1 shows schematically a processing order of temper rolling, tension levelling, coating and laser texturing,

FIG. 2a-d show different arrangements to apply a laser texturing to a steel strip in more detail, and

FIG. 3a-e show the typical surface results obtainable using laser texturing of a moving steel strip in more detail.

### DETAILED DESCRIPTION OF THE DRAWINGS

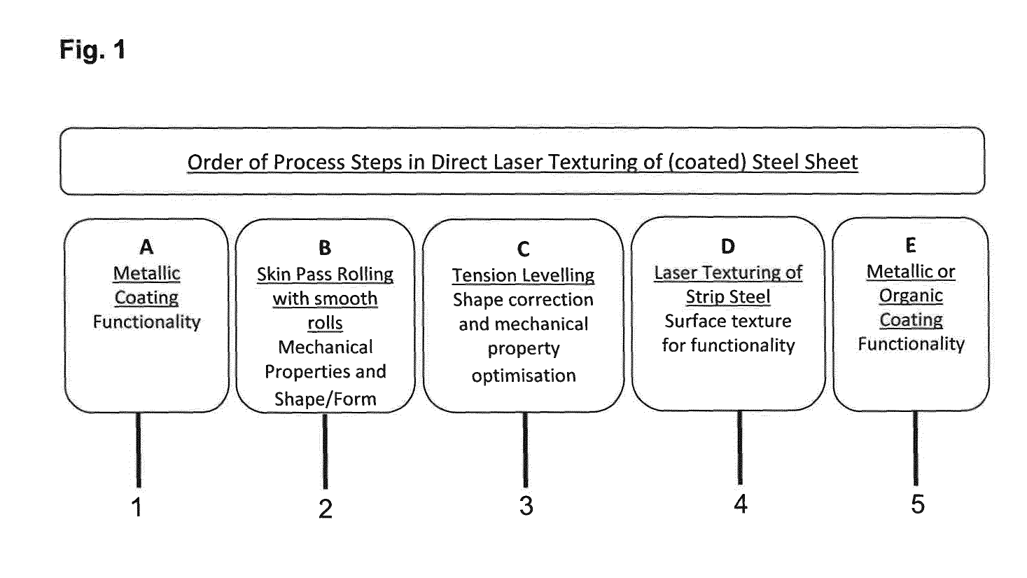

In FIG. 1 a broad schematic is provided of the processing order. The processing starts with providing a steel strip, which in most cases will be provided with a coating such as a Zn-based coating as shown in block 1. After that the steel strip is subjected to a skin pass rolling, block 2, and to tension levelling, block 3, before a texture pattern is applied by means of laser texturing, block 4. After that, optionally a further metallic or organic coating could be applied to the textured steel strip, block 5. Of course, the laser texturing may also be conducted with or without the enveloping previous processing steps.

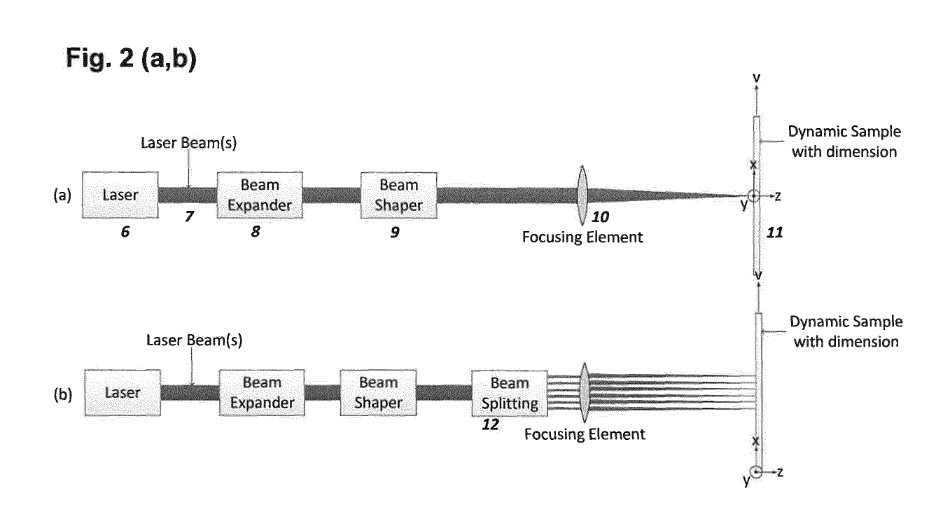

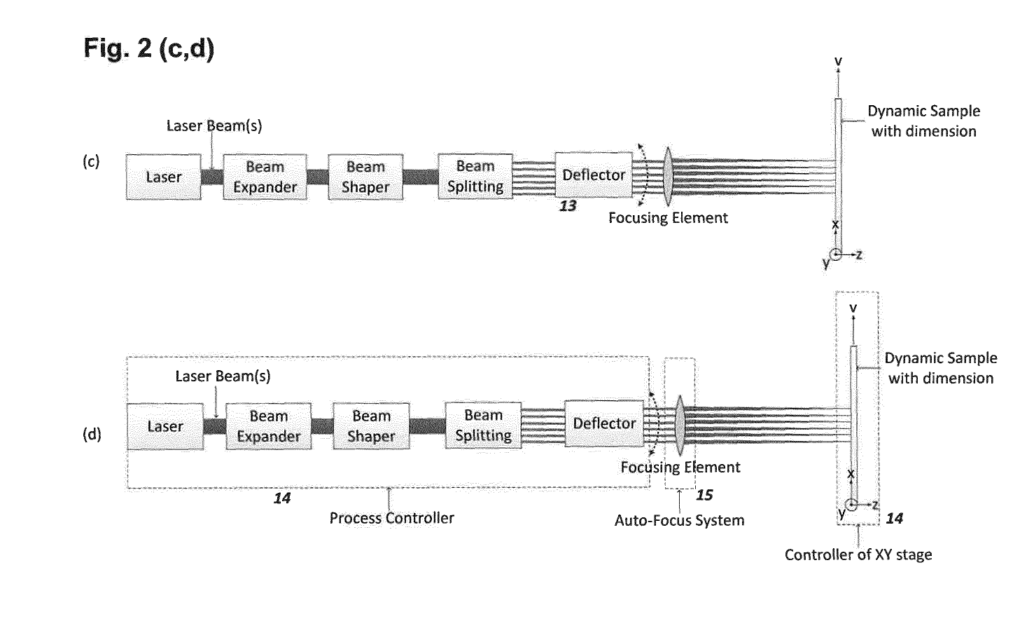

FIG. 2a shows an arrangement with a laser source 6 which generates one or more laser beams 7, a beam expander 8, a beam shaper 9 and a focussing element 10 to focus the laser beam on a steel strip 11.

FIG. 2b shows an arrangement which further comprises a beam splitter 12 to split the laser beam in a plurality of laser beams.

In the arrangement shown in FIG. 2c a beam deflector 13 is included which is used to deflect the laser beam in one, two, or even three dimensions.

In FIG. 2d control systems 14,15 for the arrangement are schematically indicated. Wherein control system is for the control of respectively laser source 6, beam expander 8, beam shaper 9, beam splitter 12 and beam deflector 13. Control system 15 is specifically for the control of focussing element 11.

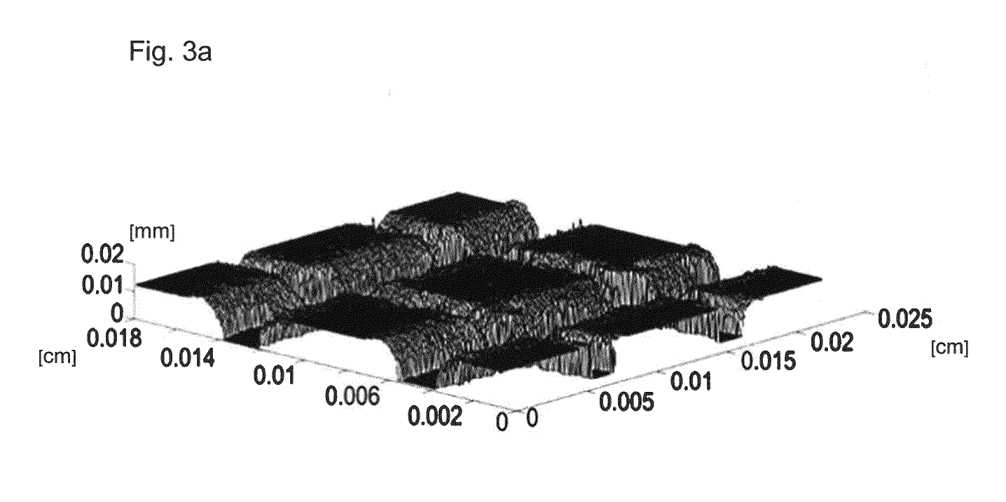

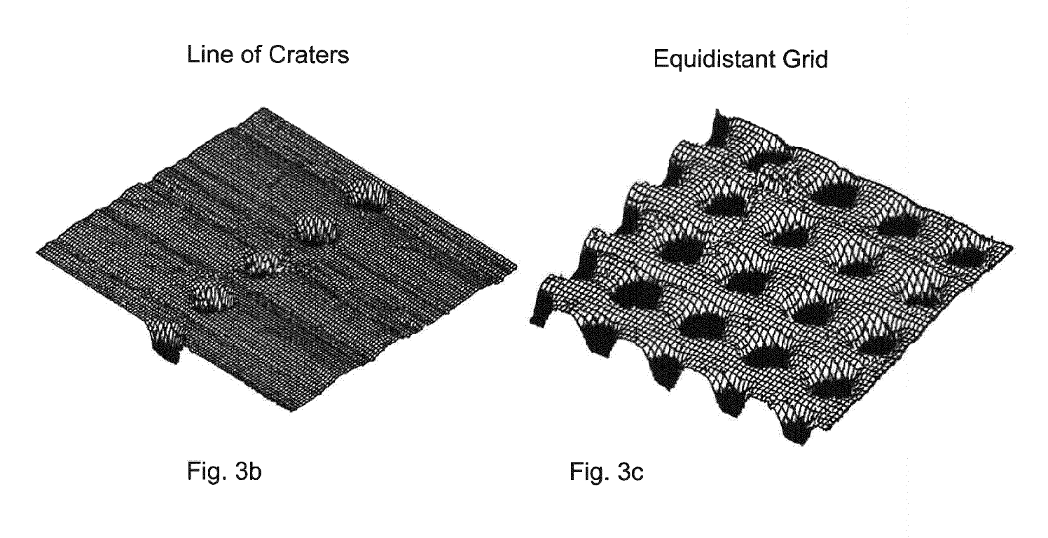

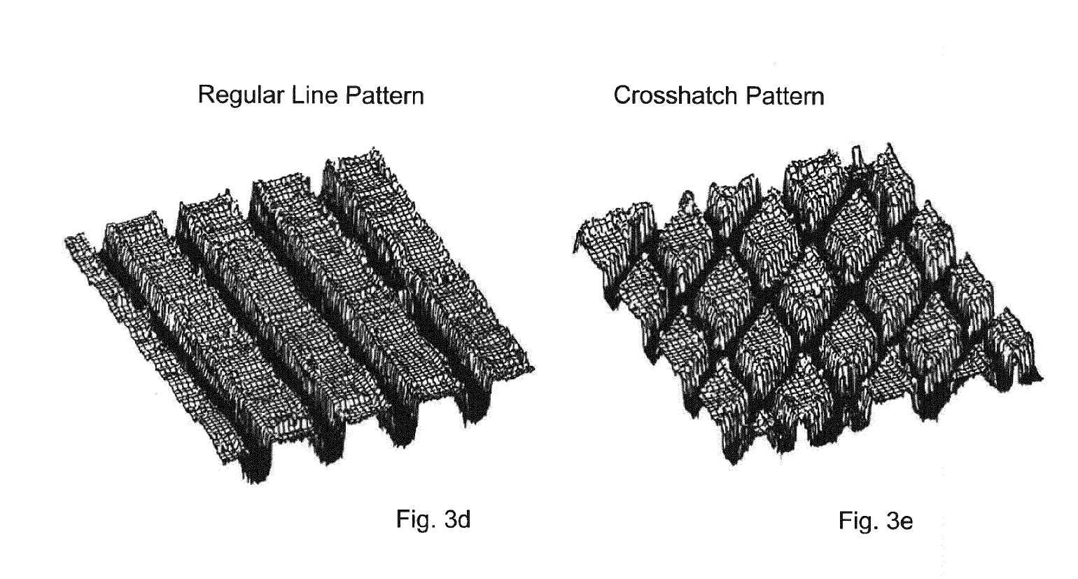

Finally FIG. 3a-e show examples of a laser applied texture on steel samples with patterns of individual craters and/or grooves, with respectively grooves at about right angles to each other, a line of craters, an equidistant grid of craters, a regular line pattern and a cross-hatch line pattern.

1. A method for finishing a steel strip comprising the texturing of the steel strip wherein a texture is applied to the surface of a moving steel strip, wherein,
a single laser beam or a plurality of laser beams is directed at the surface of a moving steel strip, and
the single laser beam or the plurality of laser beams are position controlled to apply a predetermined texture pattern on the surface of the moving steel strip.

2. The method according to claim 1, wherein the laser beams are divided in groups each with a single laser beam or a plurality of laser beams, which groups are controlled separately.

3. The method according to claim 2, wherein the groups of laser beams are positioned over the width and/or direction of movement of the steel strip with respect to each other.

4. The method according to claim 2, wherein the groups of laser beams are controlled such that adjacent parts of the texture are applied with different groups of laser beams wherein the groups have different positions with respect to each other.

5. The method according to claim 2, wherein two or more groups of laser beams are controlled to form an interference pattern with a power density distribution suitable for texturing of the moving steel strip.

6. The method according to claim 2, wherein the control comprises the control of one or more of the laser beams and the position thereof within one or more of the different groups of laser beams.

7. The method according to claim 1, wherein the control comprises the focussing of laser beams into image points on the surface of the moving steel strip, and/or modulation of the power of the laser beam or beams and/or, shaping of the power density of the laser beam or beams.

8. The method according to claim 1, wherein the control comprises a correction for changes in the z-direction of the moving steel strip.

9. The method according to claim 1, wherein the texturing is carried out after temper rolling and/or levelling of the steel strip.

10. The method according to claim 1, wherein the line speed of the steel strip is in the range of up to and including 15 m/s.

11. The method according to claim 1, wherein the laser beam or beams or part of the beams are continuous wave laser beams.

12. The method according to claim 1, wherein the single laser beam or the plurality of laser beams are pulsed laser beams, wherein
the pulse duration is in the range of 1 fs to 100 ms,
the electromagnetic radiation of each laser beam has a wave length between 200 nm-11 μm, and
with an energy density of each laser beam in the range of 1 nJ/cm2-100 J/cm2.

13. An arrangement for the finishing of steel strip, wherein the arrangement comprises at least one laser beam source to generate a single laser beam or a plurality of laser beams to apply a texture to the surface of a moving steel strip, and control means to control the single laser beam or plurality of laser beams to apply a texture on a moving steel strip.

14. The arrangement according to claim 13, wherein the control means combine two or more laser beams to form an interference pattern with a power density distribution suitable for texturing of the moving steel strip.

15. The arrangement according to claim 13, wherein a laser beam splitter is provided for one or more of the laser beam sources to split the laser beam from a laser beam source into a plurality of laser beams.

16. The arrangement according to claim 13, wherein at least one position controlled laser beam deflector is provided in the laser beam path, to deflect the laser beam in one or more directions.

17. The arrangement according to claim 13, wherein a number of laser beam devices are positioned over the width and in the length of the path of the steel strip through the arrangement.

18. The arrangement according to claim 13, wherein the arrangement comprises a temper roll mill and wherein the temper roll mill is provided with a roll or rolls with a roughness Ra (λc=2.5 mm) less than 6 μm.

19. The method according to claim 1, wherein the single laser beam or the plurality of laser beams are pulsed laser beams, wherein
the pulse duration is in the range of 1 fs to 100 ms,
the electromagnetic radiation of each laser beam has a wave length between 200 nm-11 μm, and
with an energy density of each laser beam in the range of 0.1 J/cm2 to 10 J/cm2.

20. The arrangement according to claim 13, wherein the arrangement comprises a temper roll mill and wherein the temper roll mill is provided with a roll or rolls with a roughness Ra (λc=2.5 mm) less than 2 μm.
